(19) United States
(12) Patent Application Publication
(10) Pub. No.: US 2014/0036023 A1
(43) Pub. Date: Feb. 6, 2014

(54) CONVERSATIONAL VIDEO EXPERIENCE

(71) Applicant: Volio, Inc., San Francisco, CA (US)

(72) Inventors: Ronald A. Croen, San Francisco, CA (US); Mark T. Anikst, Santa Monica, CA (US); Vidur Apparao, San Mateo, CA (US); Bernt Habermeier, San Francisco, CA (US); Todd A. Mendeloff, Los Angeles, CA (US)

(21) Appl. No.: 13/907,519

(22) Filed: May 31, 2013

Related U.S. Application Data
(60) Provisional application No. 61/653,923, filed on May 31, 2012.

(51) Int. Cl. H04N 7/14

(52) U.S. Cl. CPC H04N 7/141
USPC 348/14.01

(57) ABSTRACT

Providing a conversational video experience is disclosed. A first video segment including a question posed by a video persona and an active listening portion in which the video persona is portrayed engaging in behaviors associated with active listening is played. A user response provided by a user in response to the first video segment is received. A response concept with which the user response is associated is determined based at least in part on the user response. A next video segment to be rendered to the user is selected based at least in part on the response concept.

### CROSS REFERENCE TO OTHER APPLICATIONS

This application claims priority to U.S. Provisional Patent Application No. 61/653,923 (Attorney Docket No NUMEP002+) entitled PROVIDING A CONVERSATIONAL VIDEO EXPERIENCE filed May 31, 2012, which is incorporated herein by reference for all purposes.

### BACKGROUND OF THE INVENTION

Speech recognition technology is used to convert human speech (audio input) to text or data representing text (text-based output). Applications of speech recognition technology to date have included voice-operated user interfaces, such as voice dialing of mobile or other phones, voice-based search, interactive voice response (IVR) interfaces, and other interfaces. Typically, a user must select from a constrained menu of valid responses, e.g., to navigate a hierarchical sets of menu options.

Attempts have been made to provide interactive video experiences, but typically such attempts have lacked key elements of the experience human users expect when they participate in a conversation.

### BRIEF DESCRIPTION OF THE DRAWINGS

Various embodiments of the invention are disclosed in the following detailed description and the accompanying drawings.

FIG. 1 is a block diagram illustrating an embodiment of a conversational video runtime engine.

FIG. 2 illustrates an example of a process flow associated with a decision-making process to drive conversation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A Conversational Video runtime system in various embodiments emulates a virtual participant in a conversation with a real participant (a user). It presents the virtual participant as a video persona created based on recording or capturing aspects of a real person. The video persona conducts its side of the conversation by playing video segments on its own initiative and in response to what it heard and understood from the user side. It listens, recognizes and understands/interprets user responses, selects an appropriate response as a video segment, and delivers it in turn by playing the selected video segment. The goal of the system is to make the virtual participant in the form of a video persona as indistinguishable as possible from a real person participating in a conversation across a video channel.

In a natural human conversation, both participants acknowledge their understanding of the meaning or idea being conveyed by another side and express their attitude to the understood content, with verbal and facial expressions or other cues. In general, the participants are allowed to interrupt each other and start responding to the other side if they choose to do so.

These traits of a natural conversation have to be emulated by a conversing virtual participant to maintain a suspension of disbelief on the part of the user.

This document provides descriptions of the architectural components and approaches taken in various embodiments to conduct such a conversation in a manner that is convincing and compelling. The solutions are outlined in the following categories:
Architecture: An exemplary architecture, including some of the primary components included in various embodiments, is disclosed.
Hierarchical language understanding: Statistical methods in various embodiments exploit the specific context of a particular application to determine from examples the intent of the user and the likely direction of a conversation.
Using context: Make responses more relevant and the conversation more efficient by using what is known about the user or previous conversations or interactions with the user.
Active Listening: Techniques for simulating the natural cadence of conversation, including visual and aural listening cues and interruptions by either party.
Video Transitions and Transformations: Methods for smoothing a virtual persona's transition between video segments and other video transformation techniques to simulate a natural conversation.
Multiple Recognizers: Improving performance and optimizing cost by using multiple speech recognizers.
Multiple response modes: Allowing the user to provide a response using speech, touch or other input modalities. The selection of the available input modes may be made dynamically by the system.
Social Sharing: Recording of all or part of the conversation for sharing via social networks or other channels.
Conversational Transitions: In some applications, data in the cloud or other aspects of the application context may require some time to retrieve or analyze. Techniques to make the conversation seem continuous through such transitions are disclosed.
Integrating audio-only content: Audio-only content (as opposed to audio that is part of video) can augment video content with more flexibility and less storage demands. A method of seamlessly incorporating it within a video interaction is described.

Some of these categories overlap, but have been addressed separately for the sake of clarity of exposition.

### Architecture

A Conversational Video runtime system or runtime engine may be used to provide a conversational experience to a user in multiple different scenarios. For example:
Standalone application—A conversation with a single virtual persona or multiple conversations with different virtual personae could be packaged as a standalone application (delivered, for example, on a mobile device or through a desktop browser). In such a scenario, the user may have obtained the application primarily for the purpose of conducting conversations with virtual personae.
Embedded—One or more conversations with one or more virtual personae may be embedded within a separate application or web site with a broader purview. For example, an application or web site representing a clothing store could embed a conversational video with a spokesperson with the goal of helping a user make clothing selections.
Production tool—The runtime engine may be contained within a tool used for production of conversational videos. The runtime engine could be used for testing the current state of the conversational video in production.

In various implementations of the above, the runtime engine is incorporated and used by a container application. The container application may provide services and experiences to the user that complement or supplement those provided by the Conversational Video runtime engine, including discovery of new conversations; presentation of the conversation at the appropriate time in a broader user experience; presentation of related material alongside or in addition to the conversation; etc.

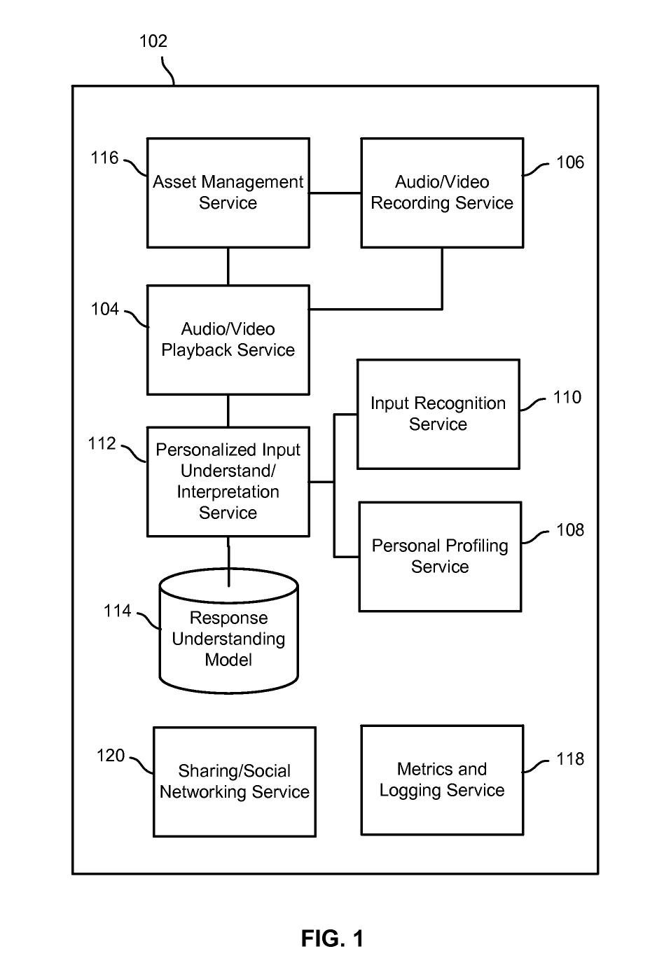

FIG. 1 is a block diagram illustrating an embodiment of a conversational video runtime engine. An embodiment of the Conversational Video runtime engine 102 may contain some or all of the following components:
Audio/Video Playback (AVP) Service 104: Plays video segments representing the persona's verbal and physical activity. The video segments are primarily pre-recorded, but could be synthesized on-the-fly.
Audio/Video Recording (AVR) Service 106: Performs capture and recording of the audio and video of the user during a Conversational Video experience for later sharing and analysis.
Personal Profiling (PP) Service 108: Maintains the personalized information about a user and retrieves that information on demand by the IR and the PIU systems (i.e., at the start of the conversation, as well as prior to each turn of the conversation). It also updates that information at the end of each turn of the conversation using new information extracted from the user response and interpreted by the PIU.
Input Recognition (IR) Service 110: Includes a speech recognition system (SR) and other input recognition such as speech prosody recognition, recognition of user's facial expressions, recognition/extraction of location, time of day, and other environmental factors/features, as well as user's touch gestures (utilizing the provided graphical user interface). The IR system accesses information retrieved by the PP system to utilize personal characteristics of the user in order to adapt the results to the user. The output of the IR system is a collection of feature values, including speech recognition values (hypotheses), speech prosody values, facial feature values, etc.
Personalized Input Understanding/Interpretation (PIU) Service 112: Interprets output of the IR system augmented with the information retrieved by the PP system. It performs interpretation in the domain of natural language (NL), speech prosody and stress, environmental data, etc. It utilizes one or more response-understanding model 114 (RUM) to map the input feature values into a concept user response (e.g. “Yup”, “Yeah”, “Sure” or nodding may all map to an Affirmative concept response). It then maps the concept response to the next video segment to play. The output of the PIU system is a time sequence indicating which video segment to play next and when to switch to the next segment.
Asset Management (AM) Service 116: Manages the retrieval and caching of all required assets (e.g. video segments, language models, etc.) and makes them available to other systems, including the AVP, IR and PIU.
Metrics and Logging (ML) Service 118: Records and maintains detailed and summarized data about conversations, including specific responses, conversation paths taken, errors, etc. for reporting and analysis.
Sharing/Social Networking (SSN) Service 120: Posts aspects of conversations, for example video recordings or unique responses, to sharing services such as social networking applications.

A specific use of the runtime engine within a container application may use some or all of the above components.

The services described above may reside in part or in their entirety either on the client device of the human participant (e.g. a mobile device, a personal computer) or on a cloud-based server. As such, any service or asset required for a conversation could be implemented as a split resource, where the decision about how much of the service or asset resides on the client and how much on the server can be made dynamically based on resource availability on the client (e.g. processing power, memory, storage, etc.) and across the network (e.g. bandwidth, latency, etc.). This decision can be based on factors such as conversational-speed response and cost.

### Hierarchical Language Understanding

A primary function within the runtime engine is a decision-making process to drive conversation. This process is based on recognizing and interpreting signals from the user and selecting an appropriate video segment to play in response. The challenge faced by the system is guiding the user through a conversation while keeping within the domain of the response understanding models (RUMs) and video segments available.

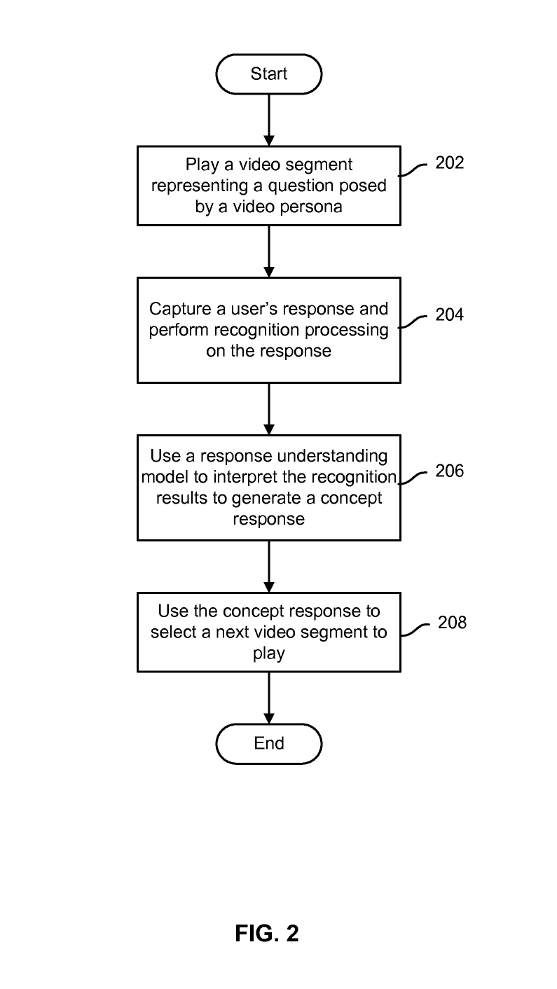

FIG. 2 illustrates an example of a process flow associated with a decision-making process to drive conversation:
The AVP system plays an initial video segment representing a question posed by the virtual persona (202); the AVR system records a user listening/responding to the question.
A user response is captured by the IR system (204) which produces recognition results and passes them to the PIU system.
The PIU system utilizes a response-understanding model (RUM) to interpret the recognition results (206) augmented with any information retrieved by the PP system. The result of this process is a concept response. For example, recognized response like “Sure”, “Yes” or “Yup” all result in a concept response of “AFFIRMATIVE”.
The concept response is used by the PIU to selects the next video segment to play (208). In one embodiment of this selection process, each concept response is deterministically associated with a single video segment.
The video segment and the timing of the start of a response are passed to the VP which initiates video playback of the response by the virtual persona.

The entire conversation is a sequence of such conversation turns. In one embodiment of this type of conversation, all possible conversation turns are represented in the form of a pre-defined decision tree/graph, where each node in the tree/graph represents a video segment to play, a RUM to map recognized and interpreted user responses to a set of concept responses, and the next node for each concept response.

Another embodiment of the system allows for a less deterministic representation of a conversation. Specifically, to enable a more natural and dynamic conversation, each conversational turn does not have to be pre-defined. To make this possible, the system will need access to:
A corpus of video segments representing a large set of possible prompts and responses by the virtual persona in the subject domain of the conversation.
A domain-wide response-understanding model (RUM) in the subject domain of the conversation. This RUM is conditioned at each conversational turn based on prompts and responses adjacent to that point in the conversation. The RUM is used, as described in the previous section, to interpret user responses (deriving one or more concept responses based on user input). It is also used to select the best video segment for the next dialog turn, based on highest probability interpreted meaning.

An example process flow in such a scenario includes the following steps:
At the start of the conversation, a pre-selected opening prompt is played by the VP.
After playing the selected prompt, the user response captured by the IR system is recognized and sent to the PIU. The PIU passes the prompt and the recognized response as inputs to the RUM and so conditioning it.
This conditioned RUM is used to select the best possible available video segment as the prompt to play representing the virtual persona's response. To make that selection, the PIU passes each available prompt to the conditioned RUM which generates a list of possible interpretations of that prompt, each with a probability of expressing the meaning of the prompt. The highest-probability interpretation defines the best meaning for the underlying prompt. In principle, the PIU can try interpreting every prompt recorded for a given video persona in the domain of the conversation, and select the prompt yielding the best meaning with the maximum probability. This selection of the next prompt represents the start of the next conversational turn. It starts by the PV playing a video segment representing the selected prompt.
For each conversational turn, the RUM can be reset to the domain-wide RUM and the steps described above are repeated. This process continues until the user ends the conversation, the system selects a video segment that is tagged as a conversation termination point or the currently conditioned RUM determines that the conversation has ended.

The above embodiments exemplify different methods through which the runtime system can guide the conversation within the constraints of a finite and limited set of available understanding models and video segments.

A further embodiment of the runtime system utilizes speech and video synthesis techniques to remove the constraint of responding using a limited set of pre-recorded video segments. In this embodiment, a RUM can generate the best possible next prompt by the virtual persona within the entire conversation domain. The next step of the conversation will be rendered or presented to the user by the runtime system based on dynamic speech and video synthesis of the virtual persona delivering the prompt.

### Using Context

The IR service accesses, and PIU service integrates, all relevant information sources to support decision-making necessary for selection of a meaningful, informed and entertaining response as a video segment (from a collection of pre-recorded video segments representing the virtual persona asking questions and/or affirming responses by the user). By using context beyond a single utterance of the user, the system can be more responsive, more accurate in its assessment of the user's intent, and can more accurately anticipate future requests.

Examples of information gathered through various sources include:
A priori knowledge of the user based on his or her identity. Examples of such knowledge include information about the user's interests, contacts and recent posts from the user's social network; gender or demographic information from a customer information database; name and address information from a prior registration process.
Information gathered by the runtime system based on prior experience within the system, even across conversations with different virtual personae. Examples of such information could include responses to prior questions such as “Are you married?”, “What kind of pet do you have?”, etc. or others that suggest interest and intent.
Information provided by the container application of the runtime engine. This can provide the context of application domain and activity prior to entering a conversation.
Extrinsic inputs collected by sensors available to the system. This could include time-of-day, current location, or even current orientation of the client device.
Facial recognition and expressions collected by capturing and interpreting video or still images of the user through a camera on the client device.

This information can be used in isolation or in combination to provide a better conversational experience by:
Providing a greater number of input features to the IR and PIU services to carry out more accurate recognition, understanding and decision-making. For example, recognition that the user is nodding would help the system interpret the utterance “uh-huh” as an affirmative response. Or the statement “I went boarding yesterday” could be disambiguated based on a recent post on a social network made by the same user describing a skateboarding activity.
Allowing the runtime engine to skip entire sections of the conversation that were originally designed to collect information that is already known. For example, if a conversation turn was originally built to determine whether the user is married, this turn could be skipped if the marital status of the user was determined in a previous conversation or from an existing user profile database.
Allowing the runtime engine to select video segments solely based on extrinsic inputs. For example, the virtual persona may start a conversation with “Good morning!” or “Good evening!” based on the time that the conversation is started by the user.

### Active Listening

To maintain a user experience of a natural conversation, the video persona needs to maintain its virtual presence, responsiveness, and to provide feedback to a user through the course of a conversation. To accomplish that, appropriate video segments need to be played when the user is speaking and responding, giving the illusions that the persona is listening to the user utterance.

In one possible embodiment of the process, active listening is simulated by playing a video segment that is non-specific. For example, the video segment could depict the virtual persona leaning towards the user, nodding, smiling or making a verbal acknowledgement (“OK”), irrespective of the user response. Of course, this approach risks the possibility that the virtual persona's reaction is not appropriate for the user response.

In another embodiment of the process, the system selects an appropriate video segment based on the best current understanding of the user's response. To be able to make this decision while the user is speaking, the recognition and understanding of an on-going partially completed response have to be performed and the results made available while the user is in the process of speaking (or providing other non-verbal input). The response time of such processing should allow a timely selection of a video segment to simulate active listening with appropriate verbal and facial cues.

The system selects, switches and plays the most appropriate video segment based on (a) an extracted meaning of the user statement so far into their utterance (and an extrapolated meaning of the whole utterance); and (b) an appropriate reaction to it by a would-be human listener. To make the timely selection and switch, it uses information streamed to it from IR and PIU system. An on-going partially spoken user response is processed by the IR and the PIU systems, and the progressively expanding results are used to make a selection of a video segment to play as a response.

The video segment selected and the time at which it is played can be used to support aspects of the cadence of a natural conversation. For example:
The video could be an active listening segment possibly containing verbal and facial expressions played during the time that the user is making the utterance.
The video could be an affirmation or question in response to the user's utterance, played immediately after the user has completed the utterance.
The system can decide to start playing back the next video segment while the user is still speaking, thus interrupting or “barging-in” to the user's utterance. If the user does not yield the turn and keeps speaking, this will be treated as a user barge-in.
The system can allow a real user to interrupt a virtual persona, and will simulate an “ad hoc” transition to an active listening shortly after detection of such interruption after selecting an appropriate “post-interrupted” active listening video segment (done within the PIU system).

### Video Transitions and Transformations

A set of techniques can be used to enable a smooth transition of a virtual persona's face/head image between video segments for an uninterrupted user experience.

The ideal case is if the video persona moves smoothly. In various embodiments, it is a “talking head.” There is no problem if a whole segment of the video persona speaking is recorded continuously. But there may be transitions between segments where that continuity is not guaranteed. Thus, there is a general need for an approach to smoothly blending two segments of video, with a talking head as the implementation we will use to explain the issue and its solution.

One approach is to record segments where the end of the segment ends in a pose that is the same as the pose at the beginning of a segment that might be appended to the first segment. (Each segment might be recorded multiple times with the “pose” varied to avoid the transition being overly “staged.”) When the videos are combined as part of creating a single video for a particular segment of the interaction (as opposed to being concatenated in realtime), standard video processing techniques can be used to make the transition appear seamless, even though there are some differences in the ending frame of one segment and the beginning of the next.

Depending on the processor of the device on which the video is appearing, those same techniques (or variations thereof) could be used to smooth the transition when the next segment is dynamically determined. However, methodology that makes the transition smoothing computationally efficient is desirable to minimize the burden on the processor. One approach is the use of “dynamic programming” techniques normally employed in applications such as finding the shortest route between two points on a map, as in navigation systems, combined with facial recognition technology. The process proceeds roughly as follows:
Identify key points on the face using facial recognition technology that we focus on when recognizing and watching faces, e.g., the corners of the mouth, the center of the eyes, the eyebrows, etc. Find those points on both the last frame of the preceding video segment and the first frame of the following video segment.
Depending on how far apart corresponding points are in pixels between the two images, determine the number of video frames required to create a smooth transition.
Use dynamic programming or similar techniques to find the path through the transition images to move each identified point on the face to the corresponding point so that the paths are as similar as possible (minimize distortion).
Other points are moved consistently based on their relationship to the points specifically modeled. The result is a smooth transition that focuses on what the person watching will be focusing on, resulting in reduced processing requirements.

In various embodiments techniques described herein are applied with respect to faces. Only a few points on the face need be used to make a transformation, yet it will generate a perceived smooth transition. Because the number of points used to create the transformation is few, the computation is small, similar to that required to compute several alternative traffic routes in a navigation system, which we know can be done on portable devices. Facial recognition has similarly been used on portable devices, and Microsoft's Kinect game controller recognizes and models the whole human body on a small device.

In various embodiments, transition treatment as described herein is applied in the context of conversational video. There is a need for many transitions relative to some other areas where videos are used for, e.g., instructional purposes, with little if any real variation in content. While some of these applications are characterized as “interactive,” they are little more than allowing branching between complete videos, e.g., to explain a point in more detail if requested. In conversational video, a key component is much more flexibility to allow elements such as personalization and the use of context, which will be discussed later in this document. Thus, it is not feasible to create long videos incorporating all the variations possible and simply choose among them; it will be necessary to fuse shorter segments.

A further demand of interactive conversation with a video persona on portable devices in some embodiments is the limitation on storage. It would not be feasible to store all segments on the device, even if there were not the issue of updates reflecting change in content. In addition, since in some embodiments the system is configured to anticipate segments that will be needed and begin downloading them while one is playing, this encourages the use of shorter segments, further increasing the likelihood that concatenation of segments will be necessary.

### Multiple Recognizers

To achieve the best speech recognition (SR) performance (minimum error rate, acceptable response time and resource utilization), more that a single SR system may be required in some implementations. Also, to reduce the cost incurred by interacting with a fee-based remote SR service, it may be desirable to balance its use with a local SR (embedded in the user device). In various embodiments, at least one local SR and at least one remote SR (network based) are included. Several cooperative schemes can be used to enable their co-processing of speech input and delegation of the authority for the final decision/formulation of the results. These schemes are implemented using an SR controller system which coordinates operations of local and remote SRs. The SR controller together with local and remote SR systems are components of the IR system.

The schemes include:

(1) Chaining

A local SR can do a more efficient start/stop analysis, and the results can be used to reduce the amount of data sent to the remote SR.

(1.1) A local SR is authorized to track audio input and detect the start of a speech utterance. The detected events with an estimated confidence level are passed as hints to the SR controller which makes a final decision to engage (to send a “start listening” command to) the remote SR and to start streaming the input audio to it (covering a backdated audio content to capture the start of the utterance).

(1.2) In addition, a local SR is authorized to track audio input and detect the end of a speech utterance. The detected events with an estimated confidence level are passed as hints to the SR controller which makes a final decision to send a “stop listening” command to the remote SR and to stop streaming the input audio to it (after sending some additional audio content to capture the end of the utterance as may be required by the remote SR). Alternatively, the SR controller may decide to rely on a remote SR for the end of speech detection. Also, a “stop listening” decision can be based on a higher-authority feedback from the PIU system that may decide that a sufficient information has been accumulated for their decision-making.

(2) Local and remote SRs in parallel/overlapping recognition

(2.1) Local SR for short utterances, both local and remote SR's for longer utterances.

To optimize recognition accuracy and reduce the response time for short utterances, only a local SR can be used. This also reduces the usage of the remote SR and related usage fees.

The SR controller sets a maximum utterance duration which will limit the utterance processing to the local SR only. If the end of utterance is detected by the local SR before the maximum duration is exceeded, the local SR completes recognition of the utterance and the remote SR is not invoked. Otherwise, the speech audio will be streamed to the remote SR (starting with the audio buffered from the sufficiently padded start of speech).

Depending on the recognition confidence level for partial results streamed by the local SR, the SR controller can decide to start using the remote SR. If the utterance is rejected by the local SR, the SR controller will start using the remote SR.

The SR controller sends “start listening” to the local SR. The local SR detects the start of speech utterance, notifies the SR controller of this event and initiates streaming of speech recognition results to the SR controller which directs them to the PIU system. When the local SR detects the subsequent end of utterance, it notifies the SR controller of this event. The local SR returns the final recognition hypotheses with their scores to the SR controller.

Upon receipt of the “start of speech utterance” notification from the local SR, the SR controller sets the pre-defined maximum utterance duration. If the end of utterance is detected before the maximum duration is exceeded, the local SR completes recognition of the utterance. The remote SR is not invoked.

If the utterance duration exceeds the specified maximum while the local SR continues recognizing the utterance and streaming partial results, the SR controller sends “start listening” and starts streaming the utterance audio data (including a buffered audio from the start of the utterance) to, and receiving streamed recognition results from, the remote SR. The streams of partial recognition results from the local and remote SRs are merged by the SR controller and used as input into the PIU system. The end of recognition notification is sent to the SR controller by the two SR engines when these events occur.

However, if the confidence score of the partial recognition results by the local SR are considered low according to some criterion (e.g., below a set threshold), the SR controller will start using the remote SR if it has not done that already.

If the utterance is rejected by the local SR, the SR controller will start using the remote SR (if it has not done that already). A video segment of a “speed equalizer” is played while streaming the audio to a remote SR and processing the recognition results.

(3) Auxiliary expert—a local SR is specialized on recognizing speech characteristics such as prosody, stress, rate of speech, etc.

This recognizer runs alongside other local recognizers and shares the audio input channel with them.

(4) A Fail-over backup to tolerate resource constraints (e.g. no network resources)

If the loss/degradation of the network connectivity is detected, the SR controller is notified of this event and stops communicating with the remote SR (i.e. sending start/stop listening commands and receiving streamed partial results). The SR controller resumes communicating with the remote SR when it is notified of a restored network connectivity.

### Multiple Response Modes

The system in various embodiments provides dynamic hints to a user of which input modalities are made available to them at the start of a conversation, as well as in the course of it. The input modalities can include speech, touch or click gestures, or even facial gestures/head movements. The system decides which one should be hinted to the user, and how strong a hint should be. The selection of the hints is based on environmental factors (e.g. ambient noise), quality of the user experience (e.g. recognition failure/retry rate), resource availability (e.g., network connectivity) and user preference. The user may disregard the hints and continue using a preferred modality. The system keeps track of user preferences for the input modalities and adapts hinting strategy accordingly.

The system can use VUI, touch-/click-based GUI and camera-based face image tracking to capture user input. The GUI is also used to display hints of what modality is preferred by the system. For speech input, the system displays a “listening for speech” indicator every time the speech input modality becomes available. If speech input becomes degraded (e.g. due to a low signal to noise ratio, loss of an access to a remote SR engine) or the user experiences a high recognition failure rate, the user will be hinted at/reminded of the touch based input modality as an alternative to speech.

The system hints (indicates) to the user that the touch based input is preferred at this point in the interactions by showing an appropriate touch-enabled on-screen indicator. The strength of a hint is expressed as the brightness and/or the frequency of pulsation of the indicator image. The user may ignore the hint and continue using the speech input modality. Once the user touches that indicator, or if the speech input failure persists, the GUI touch interface becomes enabled and visible to the user. The speech input modality remains enabled concurrently with the touch input modality. The user can dismiss the touch interface if they prefer. Conversely, the user can bring up the touch interface at any point in the conversation (by tapping an image or clicking a button). The user input preferences are updated as part of the user profile by the PP system.

For touch input, the system maintains a list of pre-defined responses the user can select from. The list items are concept responses, e.g., “YES”, “NO”, “MAYBE” (in a text or graphical form). These concept responses are linked one-to-one with the subsequent prompts for the next turn of the conversation. (The concept responses match the prompt affirmations of the linked prompts.) In addition, each concept response is expanded into a (limited) list of written natural responses matching that concept response. As an example, for a prompt “Do you have a girlfriend?” a concept response “NO GIRLFRIEND” may be expanded into a list of natural responses “I don't have a girlfriend”, “I don't need a girlfriend in my life”, “I am not dating anyone”, etc. A concept response “MARRIED” may be expended into a list of natural responses “I'm married”, “I am a married man”, “Yes, and I am married to her”, etc.

In the some embodiments, the list of concept responses is presented via a touch-enabled GUI popup window.

The user can apply a touch gesture (e.g., tap) to a concept response item on the list, to start playing the corresponding video prompt. The user can apply another touch gesture (e.g, double-tap) to the concept response item to make the item expand into a list of natural responses (in text format). In one implementation, this new list will replace the concept response list in the popup window. In another implementation, the list of natural responses will be shown in another popup window. The user can use touch gestures (e.g., slide, pinch) to change the position and/or the size of the popup window(s). The user can apply a touch gesture (e.g., tap) to a natural response item to start playing the corresponding video prompt. To go back to the list of concept responses or dismiss a popup window, the user can use other touch gestures (or click on a GUI button).

### Social Media Sharing

This section describes audio/video recording and transcription of the user side of a conversation as means of capturing user-generated content. It also presents innovative ways of sharing the recorded content data as the whole or in parts on social media channels.

During a conversation between a virtual persona and a real user, the Conversational Video runtime system performs video capture of the user while they listen to, and respond to, the persona's video prompts. The audio/video capture utilizes a microphone and a front-facing camera of the host device. The captured audio/video data is recorded to a local storage as a set of video files. The capture and recording are performed concurrently with the video playback of the persona's prompts (both speaking and active listening segments). The timing of the video capture is synchronized with that of the playback of the video prompts, so that it is possible to time-align both video streams.

Furthermore, transcriptions of the user's actual responses and the corresponding concept responses are logged and stored. The user's responses are automatically transcribed into text and interpreted/summarized as concept responses by the IR (its SR component) and the PIU systems, respectively. The automatically transcribed and logged responses may be hand-corrected/edited by the user.

Audio/video recordings and transcriptions of the user's responses can be used for multiple types of social media interactions:
A user's video data segments captured during a persona's speaking and active listening modes can be sequenced with the persona-speaking and active listening segments to reconstruct an interactive exchange between both sides of the conversation. These segments can be sequenced in multiple ways including alternating video playback between segments or showing multiple segments adjacent to each other. These recorded video conversations can be posted in part or in their entirety to a social network on behalf of the user. These published video segments are available for standalone viewing, but can also serve as a means of discovery of the availability of a conversational video interaction with the virtual persona.
Selected user recorded video segments on their own or sequenced with recorded video segments of other users engaging in a conversation with the same virtual persona can be posted to social networks on behalf of the virtual (or corresponding real) persona.
The transcribed actual or concept responses from multiple users engaging in a conversation with the same virtual persona can be measured for similarity. Data elements or features collected for multiple users by the Personal Profiling (PP) Service can also be measured for similarity. Users with a similarity score above a defined threshold can be connected over social networks. For example, fans/admirers/followers of a celebrity can be introduced to each other by the celebrity persona and view their collections of video segments of their conversations with that celebrity.

### Conversational Transitions

This section addresses the specific problem of finding an acceptable way to handle delays in deciding what the virtual persona should say next without destroying the conversational feel of the application. The delays, as noted, can come from a number of sources, such as the need to retrieve assets from the cloud, the computational time taken for analysis, and other sources.

The detection of these delay could be determined immediately prior to requiring the asset or analysis result that is the source of the delay, or it could be determined well in advance of requiring the asset (for example, if assets were being progressively downloaded in anticipation of their use and there were a network disruption).

One approach is to use transitional conversational segments, transitional in that they delay the need for the asset being retrieved or the result which is the subject of the analysis causing the delay. These transitions can be of several types:
Neutral: Simple delays in meaningful content that would apply in any context, e.g., “Let me see . . . ,” “That's a good question . . . ,” “That's one I'd like to think about . . . Hold on, I'm thinking,” or something intended to be humorous. The length of the segment could be in part determined by the expected delay.
Application contextual: The transition can be particular to the application context, e.g., “Making financial decisions isn't easy. There are a lot of things to consider.”
Conversation contextual: The transition could be particular to the specific point in the conversation, e.g., “The show got excellent reviews,” prior to a indicating ticket availability for a particular event.
Additional information: The transition could take advantage of the delay to provide potentially valuable additional content in context, without seeming disruptive to the conversation flow, e.g., “The stock market closed lower today,” prior to a specific stock quote.
Directional: The system could direct the conversation down a specific path where video assets are available without delay. This decision to go down this conversation path would not have been taken but for the aforementioned detection of delay.

### Integrating Human Agents

There may be occasions for some applications to involve a human agent. This human agent—a real person connected via a video and/or audio channel to the user—could be:

an additional participant in the conversation

a substitute for the virtual persona

In both of the above cases, the new participant could be selected from a pool of available human agents or could even be the real person on whom the virtual persona is based. The decision to include a human agent may only be taken if there is a human agent available, determined by an integration with a presence system.

Examples of scenarios in which human agents would be integrated include:
In cases where the conversation path goes outside the immediate conversation domain, the virtual persona can indicate he/she needs to ask their assistant. They would then “call out” on a speakerphone, and a real agent's voice could say hello. The virtual persona would then say, “Please tell my assistant what you want” or the equivalent. At that point, the user would interact with the agent by simulated speakerphone, with the virtual persona nodding occasionally or showing other appropriate behavior. At the end of the agent interaction, a signal would indicate to the app on the mobile device or computer that the virtual persona should begin interacting with the user. This use allows conventional agents serving, for example, call centers, to treat the interaction as a phone call, but for the user to continue to feel engaged with the video.
The integration could also be subtler, with “hidden” agents. That is, when the system can't decipher what the user is saying, perhaps after a few tries, an agent could be tapped in to listen and type a response. In some cases, the agent could simply choose a pre-written response to the question. A text-to-speech system customized to the virtual persona's voice could then speak the typed response. The video system could be designed to simulate arbitrary speech; however, it may be easier to just have the virtual persona pretend to look up the answer on a document, hiding the virtual persona's lips, or a similar device for hiding the virtual persona's mouth. The advantage of a hidden agent in part is that agents with analytic skills that might have accents or other disadvantages when communicating by speech could be used.
For a certain pattern of responses, the conversation could transfer to a real person, either a new participant or even the real person on whom the virtual participant is based. For example, in a dating scenario the conversational video could ask a series of screening questions and for a specific pattern of responses, the real person represented by the virtual persona could be brought in if he/she is available. In another scenario, a user may be given the opportunity to “win” a chance speak to the real celebrity represented by the virtual persona based on a random drawing or other triggering criteria.

### Integrating Audio-Only Content

Having video coverage for new developments or content seldom used may not be cost-effective or even feasible. This can be addressed in part by using audio-only content within the video solution. As with human agents, the virtual persona could “phone” an assistant, listen to a radio, or ask someone “off-camera” and hear audio-only information, either pre-recorded or delivered by text-to-speech synthesis. In that latter case, the new content could originate as text, e.g., text from a news site, for example. Audio-only content could also be environmental or musical, for example if the virtual persona played examples of music for the user for possible purchase.

### Producing Dialogs to Provide a Conversational Video Experience

### Introduction

This document describes components and technologies associated with the production of conversational dialogs for providing a Conversational Video experience. Several implementations of the production process are presented.

To drive conversations between a virtual persona and a user, the Conversational Video runtime system in various embodiments utilizes resources created by the production process. These resources include:
Logic for determining dialog flow. This may be in the form of a pre-determined decision or dialog tree traversed based on user responses. Or it may be a more dynamic, based on rules or statistical models.
Collections of video segments representing statements made by a virtual persona on its own initiative or in response to a user in a course of any supported conversation.
Models used to recognize and interpret the user statements made in the context of a turn in a conversation and possibly select the next video segment to play. Supported conversations belong to pre-determined conversation domains with specific (but possibly overlapping) subject matter, lexicon, semantics, and anticipated actions expected by a user.

The resources created for conversations can be shared with other conversations within the same domain or across domains where they overlap. A set of resources for a common use augmenting any domain specific resources can also be created.

In various embodiments, the production process may include one or more of the following:
Creation of video, recognition/understanding and dialog flow resources for a conversation
A model for selection of the next prompt
Auto-generation of NL concepts to aid authoring of a conversation
Supervised learning/adaptation of the NL resources based on error correction feedback from users

### Creation of Video, Recognition/Understanding and Dialog Flow Resources

This section describes creation of various resources used in various embodiments to support the CV runtime system driving a conversational dialog: video segments, input recognition and interpretation models, and decision-making logic to navigate the flow of the conversation.

First, a domain of the conversation is selected by the author in preparation for writing a script of the conversation. The author creates a script of the conversational dialog, with or without aid from an automated help system. The script includes text of the video prompts at each turn of the dialog, as well as a set of transitions to prompts for the next turn selected based on user responses.

### Video Segments

A virtual persona “comes to life” in a set of video recordings of a real person. The author writes a prompt text and shooting instructions for each video segment, and the real person enacts the prompts in the flow of a dialog. The background for each prompt reflects environmental conditions specified by the author (time of day, the place, ambient sounds, etc.)

A collection of video segments produced for the same person and representing the virtual persona grows with the creation of multiple conversational dialogs in the selected domain. For example, in the domain of a standup comedy, a comedian can create a library of video segments depicting him/her as talking on various topics of conversations from this domain. In time, the variety of responses will cover many domain topics, and it will become feasible to find most prompts among the already-recorded ones instead of recording new ones, for each new conversation.

### Input Recognition and Interpretation Models

To support VC runtime driving of conversational dialogs from a selected domain, input recognition models are created. These may include recognition models for speech, prosody and stress, facial expressions, and touch gestures. These models are selected/adapted to provide accurate recognition in real time.

A simple implementation of the speech recognition and interpretation models uses rule-based grammars that are used for both input recognition and interpretation of its meaning Those models use full-phrase grammars for speech recognition and semantic tagging. For prosody and facial expressions recognition and interpretation, tree-based statistical classifier models are used. Touch gestures are recognized and interpreted using known methods.

Other implementations of the speech recognition and interpretation models are based on statistical models. These models are often based on a corpus of possible phrases that can occur in a real conversation within a specified domain (a two-sided exchange of prompt/response statements) gathered from a variety of sources. These sources include Internet queries, a collection of written dialog scenarios, audio recordings of real conversations, and others. This material is transcribed/annotated with the text/the meaning of the exchanged statements in the context of the corresponding conversations. For other types of input (speech prosody, facial expressions, touch gestures) including those based on the user personal profile (e.g., gender, age), and environmental data (e.g., time of date, day of week, location, etc.), some phrases for the corpus cam be augmented with annotated features of such input.

Personalized input interpretation models are initially learned/adapted from the transcribed and annotated corpus of conversation dialogs from the domain. In the course of the CV runtime interacting with users engaged in the conversations, the user-generated data is logged and used to improve the quality of the models by utilizing user feedback regarding recognition and interpretation failures.

An improved implementation of the speech recognition and interpretation models uses statistical language models (SLMs) and statistical robust NL interpretation models, respectively. These models are trained from speech and text corpora covering conversations in the selected domain. For example, SLMs covering a domain of general dictation have been built for some commercially available speech recognition engines. On the other hand, creation of robust NL interpretation models for spoken dialogs is a less developed art. One simple implementation of the robust NL interpretation uses state-specific key-phrase grammars (instead of full-phrase grammars) and a model of semantic disambiguation of the multiple key-phrase matches.

In some embodiments, the robust NL parser for speech input, the classifiers for prosody and facial expression input, and added touch input, are combined into response-understanding models (RUMs). These models are created utilizing recognized inputs that include speech utterances, speech prosody, touch, and facial expressions. RUMs are used to interpret these recognized inputs as having meaning in the running context of a conversational dialog.

This implementation utilizes a domain-wide RUM. This RUM can interpret statements made by a participant of a conversational dialog (in the context of the previously-exchanged statements with another participant on the dialog).

At the start of the dialog, a participant chooses a first prompt. This prompt is given as input to the RUM which interprets it as a set of first-prompt concept hypotheses (conceptualizing the first prompt as relevant to the conversation). The meaning of the concepts is defined within the domain. For each concept hypothesis, a conditional likelihood of the concept (the meaning) of the first prompt is also output by the RUM.

If no first prompt is given, the RUM generates a set of first-prompt concept hypotheses with their unconditional (a priori) likelihoods of the concepts being chosen by the participant.

Next, another participant responds to the first prompt with a first response. The domain-wide RUM can be conditioned by the first prompt to interpret the first response. That is, given as input the first prompt and the first response, the RUM interprets the latter one as a set of first-response concept hypotheses with their likelihoods of expressing the meaning of the first response. The likelihoods are conditioned on the first prompt—response pair.

If no first response is given, the RUM generates a set of first-response concept hypotheses with their likelihoods of being chosen by the other participant conditioned on the first prompt only.

Next, the first participant responds to the first response with a second prompt. Likewise, the domain-wide RUM can be conditioned by the first prompt—response pair to interpret the second prompt. That is, given as input the first prompt, the first response, and the second prompt, the RUM interprets the latter one as a set of second-prompt concept hypotheses with their likelihoods of expressing the meaning of the second prompt. The likelihoods are conditioned on the triplet comprised of the first prompt, the first response statement, and the second prompt.

If no second prompt is given, the RUM generates a set of second-prompt concept hypotheses with their likelihoods of being chosen by the first participant conditioned on the first-prompt, the first-response pair only.

We can continue this conditioning of the RUM by adding nth prompts and nth responses and interpreting them as nth-prompt concept hypotheses and nth-response concept hypotheses, respectively. The previously exchanged statements between the participants of the dialog progressively build the context for interpretation of the subsequent statements.

If a history of the conversational dialogs between certain participants within a domain is kept, then the domain-wide RUM can be preconditioned prior to a start of a new conversation between the same participants by using the statements exchanged in the course of the prior dialogs.

### Dialog Flow Decision-Making Logic

In writing a new dialog, the author may decide to include fragments from another already-written conversation dialog and re-use its video segments and decision-making logic. In the opening and closing prompt segments, the author writes an introduction instead of an affirmation, and a closing statement instead of a question, respectively.

In some embodiments, the author creates the flow of the dialog as a decision tree/graph (a directed acyclic graph) where each node represents a turn in the conversation. For each node, the author writes a prompt as composed of an affirmation of a previous response by a user, and a question to the user (except for the opening and closing prompts). The author may choose to vary prompts for the same node depending on a variety of input (speech prosody, facial expressions, touch gestures) including those based on the user personal profile (e.g., gender, age), and environmental data (e.g., time of date, day of week, location, etc.).

For each prompt, the author generates (either explicitly or implicitly, in a literal or conceptual form) a list of sample responses anticipated from a user. For each anticipated response, the author first attempts to select an existing node with the prompt that best affirms the response. If the author decides that a new prompt is needed to adequately affirm the anticipated response and/or steer the dialog in the contemplated direction, the author creates a new node, places a transition arc to that node, and writes the new prompt. Again, the prompt may vary depending on a variety of input that complements the anticipated response.

In one version, of the implementation, the author also provides a selected set of sample responses (literal or conceptual) that if matched with the recognized user responses would trigger a transition to the new node (a state of the dialog).

In another version, the author does not provide such information. In such a version, a decision to transition to one of the nodes is made at run time, depending on a recognized and interpreted user response—usually the node with the most appropriate affirmation of that response.

In this version of the implementation, a next state prompt is selected by the CV runtime for each dialog state given the state prompt, a recognized user response, and a set of the adjacent prompts i.e., prompts in the adjacent nodes of the tree/graph (see “A model for selection of the next prompt”).

The above implementation (and its versions) does not provide any help with authoring of a conversational dialog.

An alternative implementation adds a conversation-authoring aid system. One version of this aid system helps an author to review anticipated responses to a written state prompt by listing concept responses to the prompt with their likelihoods to be spoken by a user (see “Auto-generation of NL concepts to aid authoring of a conversation”).

### A Model for Selection of the Next Prompt

With all the dialog prompts and the decision logic already authored, selection of the prompt to play at the next turn of a dialog can be based on the state prompt and a pre-defined set of affirmations (contained in the adjacent prompts).

For each dialog state given the state prompt, a recognized user response, and a set of the adjacent prompts (i.e., prompts in the adjacent nodes of the tree/graph), the prompt to play in the next turn of the dialog can be selected based on the domain-wide RUM.

Namely, at a given dialog state, the RUM is conditioned on the state prompt and the recognized response. For each adjacent prompt, the such-conditioned RUM is used to generate a list of the prompt concept hypotheses (expressing possible meaning of the prompt) with likelihoods of them being chosen (by a would-be human participant) for the next turn. The concept hypothesis with the highest likelihood (of the top of the list) is selected as the fitness value of the prompt. Finally, the prompt with the maximum fitness value is selected as the prompt to play for the next turn of the dialog.

### Auto-Generation of NL Concepts to Aid Authoring of a Conversation

To aid authoring of a conversational dialog, it is desirable for an author to be able to review, at a conceptual level, possible user responses to an authored statement of a virtual persona at each turn in the dialog. The authoring system can provide concepts of anticipated response concepts for a given prompt by the virtual persona, as an aid to the author to not miss possible response paths during the production process. The response concepts are presented in a list in the descending order of the likelihood of corresponding user responses.

To generate aid lists at the authoring time, we utilize response-understanding models (RUMs) developed for the Conversational Video runtime use in the conversation domains.

To generate the list of concepts of the anticipated user responses, the authored prompt is given as input to the appropriate domain-wide RUM. As described above, the RUM generates a set of response concept hypotheses with their likelihoods of being chosen as a user response to the prompt.

### Supervised Learning/Adaptation of NL Resources in the Context of a Conversation

To improve the NL interpretation accuracy for a conversation, in some embodiments we make use of the data created by users in a process of interaction with the application. One method to utilize that data is supervised training Supervised training uses data containing recognized user responses and subsequent user actions performed by users of an application (error correction by re-speaking a response, selecting a response from a list of pre-defined choices by a touch gesture utilizing GUI, or acceptance of the interpretation results).

A preferred implementation is described next. The application starts with a seed NL interpretation model that is acceptable for use “out of the box”, e.g. a pre-created set of RUMs, one per dialog turn, or a dialog-specific RUM.

After each failed interpretation of a user response, the user is given an option to select a response from a list of written responses best matching the response they have just given. By selecting a written response the user identifies the best-affirming prompt among the adjacent prompt segments (provided by the author). The selected written response together with the identified prompt are used as a “tag” to annotate the text of the recognized response. This “user-sourced” annotation data is collected and is integrated to the corresponding turn RUM or the dialog-specific RUM by a supervised learning algorithm at a later time (when a certain number of annotated responses for that turn's prompt have been collected).

In one implementation, the user is given an option to hand-correct the recognized text before linking it to the concept.

The user can re-state the response until it is correctly interpreted. In this case, the previously misinterpreted (and possibly, misrecognized) response attempts are annotated with the recognized text of the interpreted response and the corresponding next prompt. If recognition errors are not corrected before annotating them, they may help create a useful robust interpretation model that would work in the presence of recognition errors.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of providing a conversational video experience, comprising:
playing a first video segment including a question posed by a video persona and an active listening portion in which the video persona is portrayed engaging in behaviors associated with active listening;
receiving a user response provided by a user in response to the first video segment;
determining, based at least in part on the user response, a response concept with which the user response is associated; and
selecting based at least in part on the response concept a next video segment to be rendered to the user.

2. The method of claim 1, wherein the response concept is determined at least in part by using a response understanding model.

3. The method of claim 1, wherein the next video segment to be rendered is selected based at least in part on one or both of user profile information and other context data.

4. A conversational video runtime system, comprising:
an audio/video playback service configured to play a first video segment including a question posed by a video persona and an active listening portion in which the video persona is portrayed engaging in behaviors associated with active listening;
an input recognition service configured to receive a user response provided by a user in response to the first video segment; and
an input understanding/interpretation service configured to:
determine, based at least in part on the user response, a response concept with which the user response is associated; and
select based at least in part on the response concept a next video segment to be rendered to the user.

5. The system of claim 4, wherein the input understanding/interpretation service is configured to use a response understanding model to determine the response concept.

6. The system of claim 4, wherein the input understanding/interpretation service is configured to use one or both of user profile information and other context data to select the next video segment to be rendered.
